(19) United States
(12) Patent Application Publication
(10) Pub. No.: US 2013/0114838 A1
(43) Pub. Date: May 9, 2013

(54) HEARING DEVICE WITH A BATTERY COMPARTMENT

(71) Applicant: Siemens Medical Instruments Pte. Ltd., Singapore (SG)

(72) Inventors: CHRISTOPH BERKMANN, HEILSBRONN (DE); KLAUS BREINDL, NUERNBERG (DE); VOLKER GOLY, ERLANGEN (DE); JOSEPH SAUER, STRULLENDORF (DE); FRIEDRICH ZENK, HEMHOFEN (DE)

(73) Assignee: SIEMENS MEDICAL INSTRUMENTS PTE. LTD., SINGAPORE (SG)

(21) Appl. No.: 13/671,737

(22) Filed: Nov. 8, 2012

(30) Foreign Application Priority Data
Nov. 8, 2011 (DE) 10 2011 085 928.4

(51) Int. Cl. H04R 25/00

(52) U.S. Cl. CPC H04R 25/602
USPC 381/323

(57) ABSTRACT

A hearing device has a battery compartment for mounting a battery and is provided in a housing. While the battery compartment is being closed there is a risk that a contact element projecting into the battery compartment causes a short circuit between the poles of the battery. The hearing device has a contacting device for the battery that is easy to manufacture. In the battery compartment, a contact element is provided for electrical contacting of the battery which can be deflected against a spring force when inserting the battery. A contact region of the contact element as a result presses against the battery when the battery is inserted. The contact element has an abutment device formed from an electrically insulating material with a surface disposed obliquely in respect of a direction of insertion of the battery, against which the battery abuts when the contact region is deflected.

### CROSS-REFERENCE TO RELATED APPLICATION

This application claims the priority, under 35 U.S.C. §119, of German application DE 10 2011 085 928.4, filed Nov. 8, 2011; the prior application is herewith incorporated by reference in its entirety.

### BACKGROUND OF THE INVENTION

### Field of the Invention

The invention relates to a hearing device with a battery compartment, into which a battery can be inserted along a direction of insertion and in which a contact element configured for electrical contacting of the battery is disposed. The term hearing device here means in particular a hearing aid. However, the term additionally also covers other wearable and non-wearable acoustic devices such as headsets, headphones and suchlike.

Hearing aids are wearable hearing devices which are configured to assist the hard of hearing. In order to accommodate the numerous individual requirements, different styles of hearing aids such as behind-the-ear hearing aids (BTE), hearing aids with an external earpiece (RIC: receiver in the canal) and in-the-ear hearing aids (ITE), e.g. including concha hearing aids or canal hearing aids (ITE, CIC), are made available. The hearing aids listed by way of example are worn on the outer ear or in the auditory canal. Furthermore however, bone conduction hearing aids, implantable or vibrotactile hearing aids are also available on the market. In this case, stimulation of the damaged hearing is effected either mechanically or electrically.

Hearing aids basically have as their essential components an input converter, an amplifier and an output converter. The input converter is as a general rule a receiving transducer, for example a microphone, and/or an electromagnetic receiver, for example an induction coil. The output converter is usually implemented as an electroacoustic converter, for example a miniature loudspeaker, or as an electromechanical converter, for example a bone conduction earpiece. The amplifier is normally integrated into a signal processing unit. This basic structure is illustrated in FIG. 1 using the example of a behind-the-ear hearing aid. One or more microphones 2 for receiving the ambient sound are built into a hearing-aid housing 1 for wearing behind the ear. A signal processing unit 3, which is likewise integrated into the hearing-aid housing 1, processes the microphone signals and amplifies them. The output signal from the signal processing unit 3 is transmitted to a loudspeaker or earpiece 4, which outputs an acoustic signal. The sound is transmitted if need be by way of a sound tube, which is fixed in the auditory canal by an otoplastic, to the eardrum of the device wearer. The power supply for the hearing aid and in particular that for the signal processing unit 3 is provided by a battery 5 likewise integrated into the hearing-aid housing 1. To mount the battery 5 in the hearing aid housing 1 the latter can have a battery compartment, into which the battery 5 can be inserted. In order to produce an electrical contact between the battery 5 inserted in the battery compartment and the electronics of the hearing aid, corresponding contact elements for the two poles of the battery can be provided in the battery compartment. To prevent intermittent electrical contact, as can occur for example if the hearing aid is shaken, the contact elements should firmly abut the surface of the battery poles. For this purpose provision can be made for the contact elements to be pressed against the battery by a spring mechanism. However, the problem with this type of contacting is that the spring elements expand once the battery is removed from the battery compartment and as a result the contact elements project at least somewhat into the space previously occupied by the battery. If a new battery is then inserted into the battery compartment, a contact element projecting into the battery compartment can cause a short circuit between the two poles of the battery, if it projects so far into the battery compartment that it is touched by both poles at the same time during insertion.

To prevent this, provision can be made for inserting the battery not directly into the battery compartment, but providing a support that can be pivoted out of the battery compartment, into which the battery can be placed and which can then be pivoted back into the battery compartment with the battery inserted. This support can then have a shield which prevents the contact elements from touching the battery when the support is pivoted inward. Only when the battery is in its rest position in the battery compartment are the contact elements also in contact with the battery.

### SUMMARY OF THE INVENTION

It is accordingly an object of the invention to provide a hearing device with a battery compartment which overcomes the above-mentioned disadvantages of the prior art devices of this general type, which has an easy-to-manufacture contacting device for a battery for the hearing device.

In the case of the inventive hearing device provision is made for a battery compartment, into which a battery can be inserted along a direction of insertion. In the battery compartment is a contact element which is configured for the electrical contacting of the battery. The contact element is configured and disposed in the battery compartment such that when a battery compartment is empty it has a rest position in which a contact region of the contact element projects into the space to be occupied by the battery. The contact region is held there by a spring force.

When the battery is inserted into the battery compartment the contact region is deflected against the spring force. When the battery is fully inserted the contact region therefore presses against the battery, so that it creates a reliable electrical contact.

To prevent a short circuit between the two poles of the battery being caused by the contact element during the insertion, the contact element contains, in the case of the inventive hearing device, an abutment device, such as a small plastic plate, formed from an electrically insulating material. This has a surface disposed obliquely in respect of the direction of insertion, onto which the battery abuts during the insertion when the contact region is deflected. In other words, the battery slides along the oblique surface. In this case the force exerted on the oblique surface by the battery is deflected because of the obliqueness such that some of the force of the spring force is counteracted and so deflects the contact region from its rest position in the manner described.

The inventive hearing device has the advantage that the special configuration and arrangement of the contact element itself prevents a short circuit occurring when inserting and also when removing the battery. There is now no further need for an expensive shield on a pivotable support.

In some cases it is expedient if that part of the contact element which projects into the space to be occupied by the battery in the battery compartment is as small as possible. Otherwise there is a risk that the contact element or a fastening device by which the contact element is held in the battery compartment will be damaged if the user for example presses the battery too firmly into the compartment. Accordingly one embodiment of the inventive hearing device provides that the contact element has a depressed-center region which contains the abutment device, i.e. for example the plate, and/or the contact region. A depressed center can be created simply and inexpensively even in the case of the generally relatively delicate contact elements of a hearing device and still enables a contact region projecting far into the space to be occupied by the battery to be provided, as well as, if desired, an oblique surface forming the abutment device.

In connection with the configuration of the abutment device it has been found that high mechanical demands are placed thereon. Frequent changing of the battery of a hearing device results in abrasion of the electrically insulating material of the abutment device, which in turn can lead to a short circuit. To this end, embodiments of the inventive hearing device are described below which have proven particularly robust in connection with the mechanical demands.

Thus one embodiment of the inventive hearing device has an abutment device which contains a plate that is attached to an electrical conductive element of the contact element, such as a metal contact arm. Such a plate can be easily and reliably attached to the electrical conductive element and can be made thick enough so that a short circuit does not occur for the expected service life of the hearing device despite abrasion.

The abutment device can also contain a paint which is disposed on a surface of an electrically conductive region of the contact element disposed obliquely in respect of the direction of insertion. The use of paint has the advantage here that an abutment device can be provided therewith on a contact element of any shape, as the paint can be applied as a liquid.

To obviate the need for bonding or similar attachment steps, the abutment device, or part thereof, can also be formed by extrusion-coating a section of the contact element with the electrically insulating material. This then automatically results in a form-fit between the abutment device and the section of the contact element bearing it.

To enable the abutment device to be manufactured separately from the electrically conductive part of the contact element, the abutment device can also contain a cap, which in the course of manufacture is then placed over an electrical conductive element of the contact element.

In order to be independent of the shape of the electrically conductive parts of the contact element, provision can also be made for the abutment device to contain a body formed from the electrically insulating material, the body having a wedge-shaped region. The surface disposed obliquely in respect of the direction of insertion for deflecting the insertion force is then a component part of the wedge-shaped region.

The spring force by which the contact region is pressed against the battery can be created in accordance with an embodiment of the inventive hearing device that is particularly easy to manufacture by configuring at least part of the contact element as a flat spring.

The electrically insulating material for forming the abutment device can, as already described, be a paint. Other polymers are also suitable. It is also possible to oxidize a surface of a metal of the contact element and thereby form an electrically insulating oxide layer. Besides the electrically insulating properties it is however also necessary, depending on how obliquely the surface is disposed in respect of the direction of insertion, for the battery to be able to slide along the surface with as little friction as possible while it is sliding into the battery compartment. In this connection polyoxymethylene (POM) has proven particularly expedient as an electrically insulating material. It has high rigidity and nevertheless enables a surface with a low friction coefficient to be formed.

Other features which are considered as characteristic for the invention are set forth in the appended claims.

Although the invention is illustrated and described herein as embodied in a hearing device with a battery compartment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a structure of a behind-the-ear hearing aid according to the prior art;

FIG. 2 is a diagrammatic, side view of a battery compartment of an embodiment of the hearing device during insertion of a battery according to the invention;

FIG. 3 is a diagrammatic, side view of the hearing device according to FIG. 2 with a battery fully inserted into the battery compartment;

FIG. 4 is a diagrammatic, perspective view of a contact element according to another embodiment of the hearing device according to the invention;

FIG. 5 is a schematic representation of the contact element according to another embodiment of the hearing device according to the invention; and

FIG. 6 is a diagrammatic, perspective sectional view of the battery compartment of another embodiment of the hearing device according to the invention.

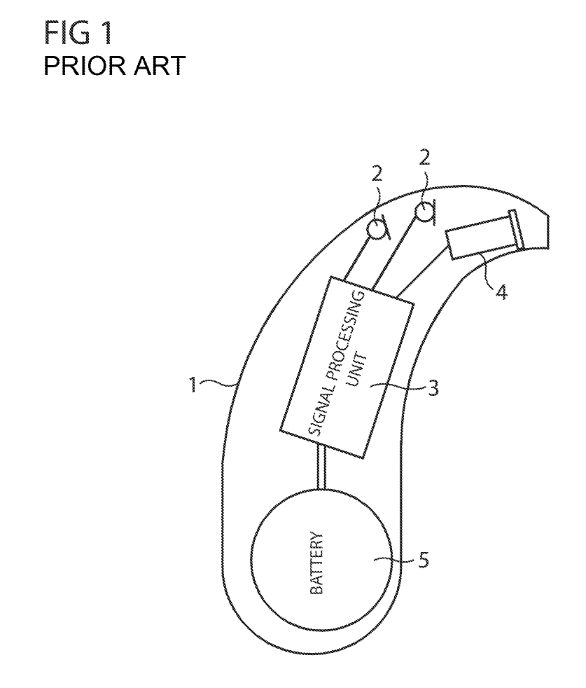

### DETAILED DESCRIPTION OF THE INVENTION

The examples represent preferred embodiments of the invention.

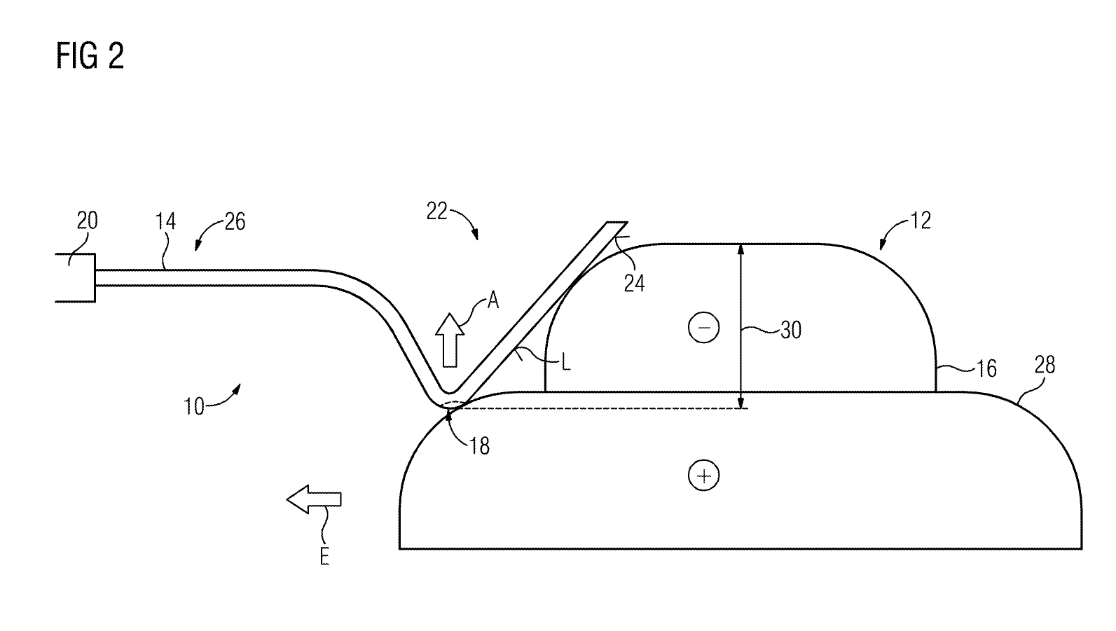

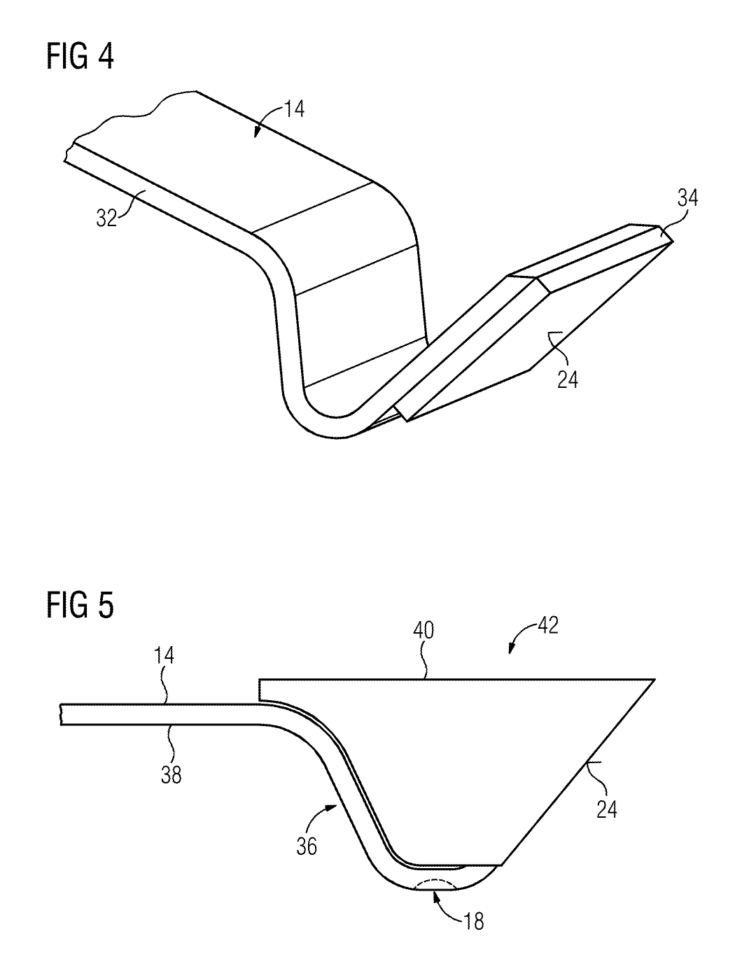

Referring now to the figures of the drawing in detail and first, particularly, to FIG. 2 thereof, there is shown a battery compartment 10 into which a battery 12 in inserted along a direction of insertion E. The battery compartment 10 can for example be part of a behind-the-ear hearing aid or of an in-the-ear hearing aid. The battery 12 can for example be a coin cell. A contact element 14 projects into a hollow space of the battery compartment 10 in which the battery 12 is to be mounted. The contact element 14 forms a contact arm, via which a current can be tapped from a negative pole 16 of the battery 12 when the battery 12 is fully inserted into the battery compartment 10. For tapping the current from the negative pole 16 the contact element 14 has an electrically conductive contact region 18. The contact element 14 is held by a mounting device 20 on a non-illustrated wall of a hearing aid housing of the hearing aid. The contact element 14 is formed from a metal flat spring. The flat spring is shown in FIG. 2 is a side view, in which its thickness and longitudinal extension are apparent. One width of the flat spring, i.e. an extension of the flat spring in a direction perpendicular to the plane of the drawing, is larger than the thickness apparent in FIG. 2 (see the perspective representation in FIG. 4).

The flat spring of the contact element 14 has a depressed-center region 22 at one end. A depressed-center section here means a U-shaped or V-shaped curved section of the flat spring. The contact region 18 is located at a tip of the depressed-center region 22 which projects into the space of the battery compartment 10 to be occupied by the battery 12.

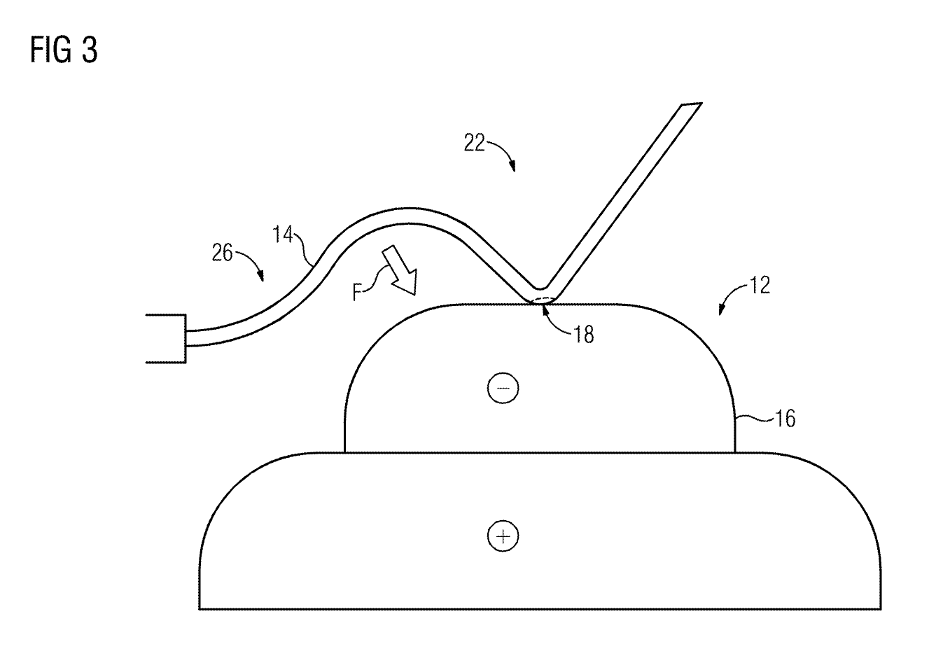

In the depressed-center region 22 the contact element 14 has an abutment area 24 oriented obliquely in respect of the direction of insertion E. The abutment area 24 is coated with an electrically insulating paint L. The depressed-center region 22 can be deflected upward from the rest position shown in FIG. 2 which it assumes when the battery compartment is empty. In so doing, a sprung section 26 of the contact element is curved (see FIG. 3).

The paint layer of the surface region 24, i.e. the paint L, forms an abutment device, along the oblique surface of which the battery slides when the contact region 18 is deflected. When the battery 12 is inserted into the battery compartment along the direction of insertion E the contact region 18 touches a positive pole 28 of the battery 12. At the same time the negative pole 16 abuts the abutment area 24. Thanks to the paint L the abutment area 24 is electrically insulated, so that in this case no short circuit occurs at the battery 12.

A user of the hearing aid exerts an insertion force on the battery 12 in the direction of insertion E during the insertion of the battery 12. Some of the insertion force is deflected upward by the obliqueness of the abutment area 24. The resulting deflection force A deflects the contact region 18 and in so doing curves the sprung region 26. The battery 12 in this way slides under the depressed-center region 22 into the battery compartment 10. Overall as a result the contact region 18 is deflected around a deflection path 30 in the battery compartment 10. This produces a corresponding reset force of the sprung region 26, which counteracts the deflection force A.

FIG. 3 shows the battery 12 in the fully inserted state. Thanks to the sprung region 26 the depressed-center region 22 of the contact element 14 and thus the contact region 18 is pressed by a reset force F against the negative pole 16 of the battery 12. This produces a more reliable electrical contact between the contact region 18 and the negative pole 16.

To apply the paint to the abutment area 24, the paint can be sprayed or brushed on. Provision can also be made to dip the region of the depressed-center region 22 to be painted into the paint.

Further options are described below, on the basis of FIG. 4 to FIG. 6, for providing, on a contact element, a surface region of an electrically insulating abutment element obliquely disposed in respect of a direction of insertion of a battery. In FIG. 4 to FIG. 6 elements which correspond in function to the elements shown in FIG. 2 and FIG. 3 are provided with the same reference characters as in FIG. 2 and FIG. 3 respectively.

FIG. 4 shows the contact element 14, whereby a plate 34 is attached to a depressed-center region 22 of a flat spring 32. The plate 32 is manufactured from an electrically insulating material, for example POM. The plate 34 can for example be bonded to the flat spring 32. Thanks to the plate 34 an insulating abutment area 24 is likewise provided, which prevents a short circuit when a battery is inserted.

FIG. 5 shows the contact element 14 in which a bent-down end 36 of a flat spring 38 ends in a contact region 18. A block 40 made of an electrically insulating material is attached to the bent-down end 36 of the flat spring 38. The block 40 has a wedge-shaped region 42, one wedge surface of which forms an abutment area 24 disposed obliquely to a direction of insertion of a battery. The block 40 can for example be bonded to the flat spring 38.

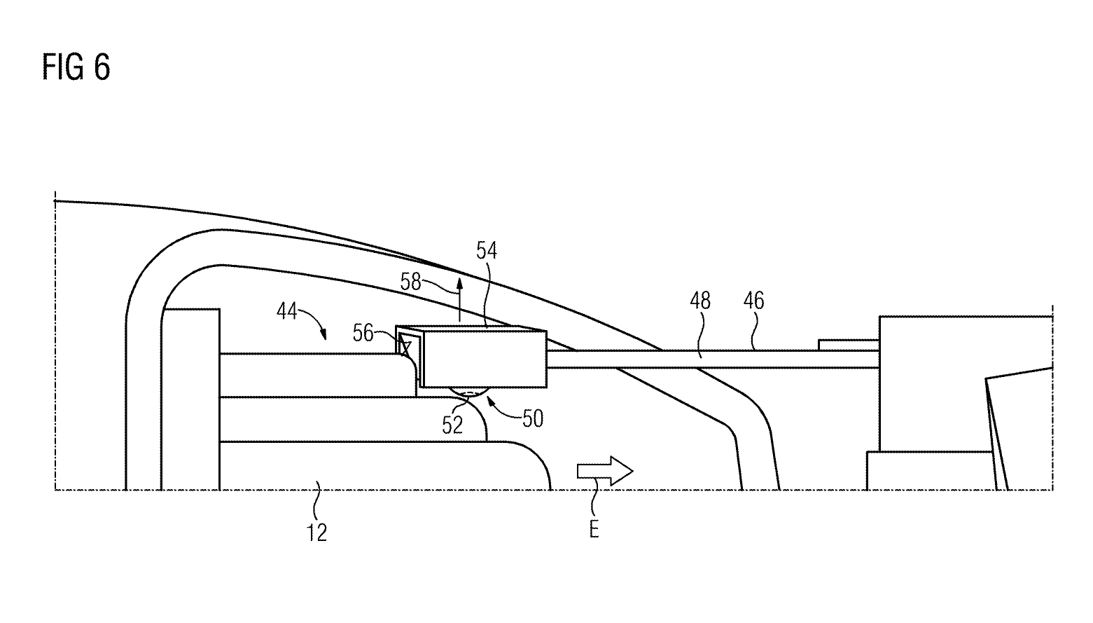

FIG. 6 shows a battery compartment 44, into the hollow space of which a contact element 46 projects. The contact element 46 contains a flat spring 48, the end of which projecting into the battery compartment 44 has a depressed-center section 50 with a contact region 52. The depressed-center section 50 is extrusion-coated with an electrically insulating material, which as a result forms an upper part 54 connected in form-fit manner to the depressed-center section 50. To insert a battery 12 into the battery compartment 44, the battery 12 must be inserted along a direction of insertion E into the battery compartment 44. During the insertion the battery 12 comes into abutment with an abutment area 56 of the upper part 54 disposed obliquely in respect of the direction of insertion E. As a result the depressed-center section 50 is deflected with the contact region 52 into a direction of deflection 58, so that the contact element 46 is bent and the battery 12 can slide through under the contact element 46. As the flat spring 48 is flexible, the contact region 52 is hereby pressed against the battery 12.

An inclination of the abutment areas 24, 56 obliquely disposed in respect of the direction of insertion can be between 10° and 80°, preferably between 30° and 60°.

The examples show how by providing a wall made of plastic on a contact element which is oriented obliquely in respect of a direction of insertion of a battery, two functions can be provided simultaneously in a battery compartment of a hearing device: firstly a short circuit while a battery is being inserted can be effectively prevented. Secondly an insertion force acting on the contact element because of the insertion can be favorably deflected such that pretensioning is created in the contact element which can be used to exert a contact force of a contact region of the contact element on the battery.

1. A hearing device, comprising:
a battery compartment for receiving a battery to be inserted along a direction of insertion; and
a contact element disposed in said battery compartment and having a contact region for electrical contacting of the battery, wherein by inserting the battery said contact region of said contact element can be deflected against a spring force and when the battery is fully inserted said contact region as a result presses against the battery, said contact element further having an abutment device formed from an electrically insulating material with a surface obliquely disposed in respect of the direction of insertion, against said surface the battery abuts when said contact region is deflected.

2. The hearing device according to claim 1, wherein said contact element has a depressed-center region which has at least one of said abutment device or said contact region.

3. The hearing device according to claim 1, wherein:
said contact element has an electrical conductive element; and
said abutment device has a plate attached to said electrical conductive element of said contact element.

4. The hearing device according to claim 1, wherein:
said contact element has an electrically conductive region; and
said abutment device has a paint which is disposed on said surface of said electrically conductive region of said contact element, said surface being disposed obliquely in respect of the direction of insertion.

5. The hearing device according to claim 1, wherein said abutment device is formed at least partially by extrusion-coating a section of said contact element supporting said abutment device with said electrically insulating material.

6. The hearing device according to claim 1, wherein:
said contact element has an electrically conductive region; and
said abutment device contains a cap which is placed over said electrical conductive region of said contact element.

7. The hearing device according to claim 1, wherein said abutment device has a body formed from said electrically insulating material, said body having a wedge-shaped region.

8. The hearing device according to claim 1, wherein at least part of said contact element is configured as a flat spring.

9. The hearing device according to claim 7, wherein said electrically insulating material contains polyoxymethylene.
